(19) United States
(12) Patent Application Publication
(10) Pub. No.: US 2008/0121753 A1
(43) Pub. Date: May 29, 2008

(54) Positive lift vehicle

(76) Inventors: Jose E. Vazquez, Escondido, CA (US); Robert G. Calderwood, Ranchita, CA (US)

Correspondence Address: CALIF KIP TERVO, 6387 CAMINITO LAZARO, SAN DIEGO, CA, 92111, US

(21) Appl. No.: 11/818,270

(22) Filed: Jun. 13, 2007

Related U.S. Application Data
(60) Provisional application No. 60/813,124, filed on Jun. 13, 2006.

(51) Int. Cl. B64B 1/20; B64C 27/22; B64B 1/34

(52) U.S. Cl. 244/26; 244/6; 244/12.2; 244/73 C

(57) ABSTRACT

An air vehicle includes a body having a top and a bottom and a support platform for carrying cargo such a people or equipment. An impeller mounted on the body is powered, such as by a motor, for rotating so as to create low pressure on the top of the body relative to the pressure on the bottom of the body so as to create lift. The body may contain buoyant gas sufficient to aid in lift. Air from the impeller may be directed to directionally control the vehicle. A plurality of impellers may be used.

### CROSS-REFERENCE TO RELATED APPLICATIONS

This application claims the benefit of U.S. Provisional Application No. 60/813,124, filed Jun. 13, 2006.

### FIELD OF THE INVENTION

This invention relates to the field of heavier-than-air vehicles. More particularly, the invention relates to a means for rendering heavier-than-air vehicles capable of takeoff, maneuvering, and landing without the need for long runways, wide wings, and wide, rotating rotor blades.

### BACKGROUND OF THE INVENTION

There are two general classes of vehicles capable of flying above the earth's surface; lighter-than-air vehicles, whose overall premise is that the weight of the vehicle is less than the weight of the air it displaces, thus “floating” in the air, and heavier-than-air vehicles that are heavier than the air they displace yet able to rise and fly by developing aerodynamic lift over some of the upper part of their body.

In heavier-than-air vehicles, the “lift” is developed most popularly by application of an air foil passing through the air to produce an area of reduced pressure above the vehicle. According to Bernoulli's principle, this area of reduced pressure promotes lifting the vehicle into the air as the air pressure on other parts of the vehicle, such as the bottom, remain unaffected. Typical examples of air foils are the wings of airplanes and the blades of helicopters. Unfortunately, the required length of these air foils is great, i.e., the wings and rotor are long, and the area on the ground required for safe operation of them (for takeoff and landing) is sufficiently large that they cannot operate safely in close quarters.

A method other than Bernoulli's principle has been postulated, namely mechanical removal of the air immediately above the vehicle creating an area of reduced pressure and allowing the atmospheric air pressure under the vehicle to again “lift” it off the ground. This is thought by some to be the process by which bumble bees fly as their body weight is too great for the size and shape of their wings using Bernoulli's principle. This method has not, to date, been significantly developed enough to produce operation of vehicles to transport humans and cargo above the ground. It is the subject of this provisional patent application.

### SUMMARY OF THE INVENTION

The invention comprises a vehicle having a platform, on which to support or carry persons or cargo, where the platform is encased in an enclosed body with a combined overall low center of gravity. An impeller is mounted for rotation at the top of the body powered by a motor located somewhere on the vehicle, preferably in the lower, central part, of the body. The impeller is designed to rotate at high speed to remove the air and the accompanying air pressure from the area about the impeller, thereby allowing the vehicle to be “lifted” into the air by the air pressure surrounding the lower part of the vehicle. In one embodiment, the impeller is magnetically attached to the drive system. In another embodiment, the body is hung below an envelope that is partially or fully filled with a buoyant gas, such as hydrogen or helium, to lessen the mass of the overall vehicle and improve the lift provided by the impeller.

It is preferred that the design of the vehicle allows for controlling the flow of air, displaced from the top of the vehicle, to cascade outward and downward over the vehicle's body to provide currents of air that may be deflected by vanes or other control surfaces mounted on the body, to direct the currents in order to change the direction of the vehicle's path over the ground.

### BRIEF DESCRIPTION OF THE DRAWINGS

FIG. 1 is a top view, partly in schematic, of an embodiment of this invention;

FIG. 2 is a perspective view of the vehicle shown in FIG. 1;

FIG. 3 is another schematic of an embodiment of this invention showing the location of the power source for the impeller;

FIG. 4 is an illustrative view of a multiple-body vehicle embodying this invention;

FIG. 5 is an illustrative side view of a van-type vehicle utilizing two drive impellers according to the teachings of this invention;

FIG. 6 is a top view of the embodiment shown in FIG. 5;

FIG. 7 is an illustrative side view of a concept car utilizing this invention;

FIG. 8 is an illustrative end view of the embodiment shown in FIG. 7;

FIG. 9 is an illustrative view of a larger vehicle utilizing this invention and the location of controlling anti-rotation vanes and other areas of the vehicle;

FIG. 10 is an illustrative top view of the embodiment shown in FIG. 9;

FIG. 11 is an illustrative view of a vehicle utilizing this invention in an environment requiring the vehicle to float on a body of water; and,

FIG. 12 is an illustrative view of a vehicle utilizing an envelope of helium as well as control surfaces in order to operate more efficiently.

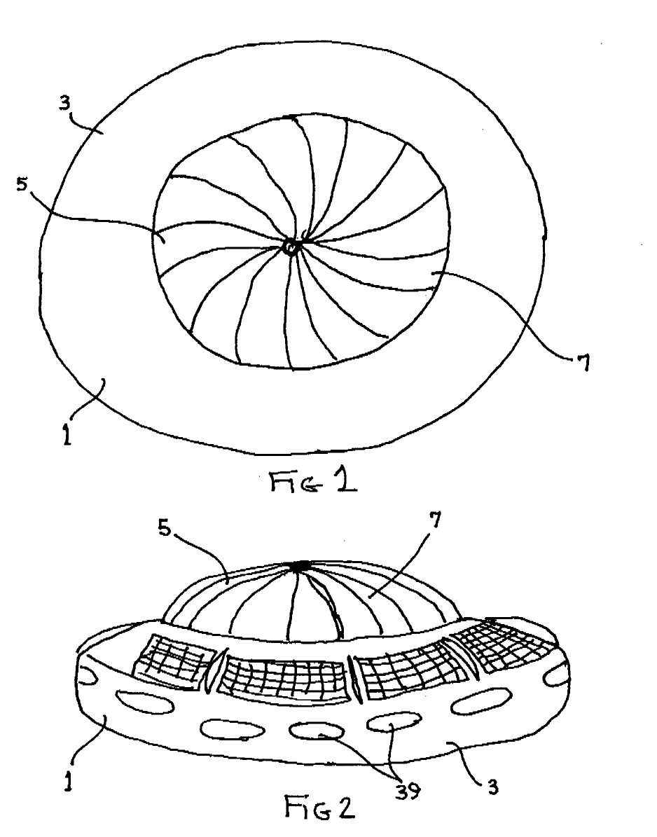

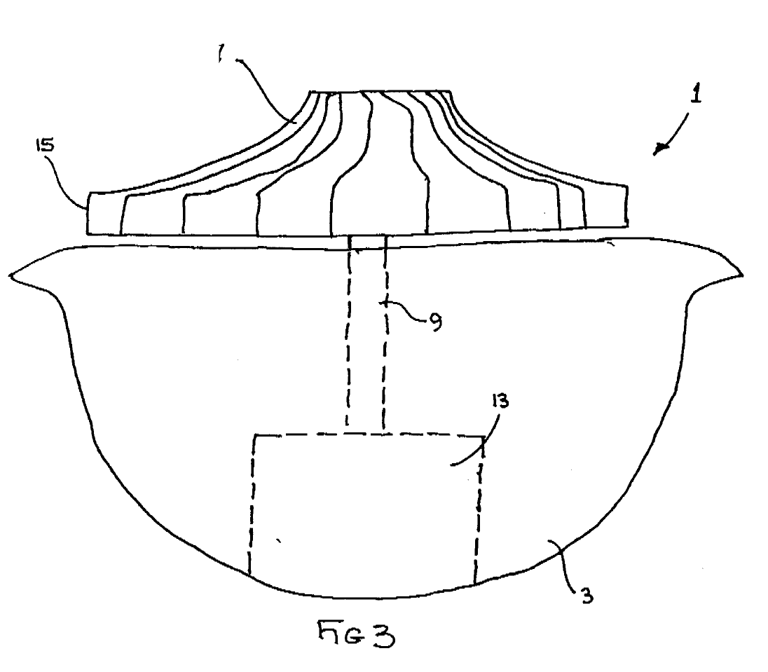

### DETAILED DESCRIPTION OF THE INVENTION

Turning now to the drawings, wherein like elements carry like numerals throughout the 12 Figures, the Figures show a vehicle 1 comprising a body 3, generally configured as an enclosed vessel, having a passenger and cargo platform interior thereof (not shown) and a top 5 centrally located above body 3. In general, while vehicle 1 remains unpowered, body 3 and top 5 are pressurized equally by the surrounding air. General air pressure at sea level is about 14.7 pounds per square inch gauge but may vary slightly depending upon local weather conditions. Suffice it to say, both body 3 and top 5 are stabilized in the surrounding air with the same pressure pressing down on the top of them as inward pressure about the sides and upward pressure from below body 3.

Top 5 contains an impeller 7 that is preferably mounted for rotation on a drive shaft 9, such as shown in FIG. 3, driven by a motor 13, preferably located centrally in the bottom or lower part of body 3 so as to give vehicle 1 a stabilizing low center of gravity. Impeller 7 may be of any type that performs the function of rotating at a high speed that draws in air from above top 3 and discharges it outwardly from the outer circumference 15 of impeller 7. The intended result of rotation of impeller 7 is to reduce the air pressure adjacent top 5, thus allowing vehicle 1 to be rendered lighter than the air it displaces and therefor allowing vehicle 1 to float in the air. Air pressure about the sides of vehicle 1 will prevent any sideways movement until altered by air currents or other control mechanisms.

Maneuvering of vehicle 1 may be accomplished by a number of methods. One would be to mount controllable vanes 17 on body 3 that allows the air, discharged from impeller outer circumference 15 to cascade downward over the surface of body 3, to be diverted one way or the other by vanes 17 to provide forces to urge vehicle 1 in one direction or another.

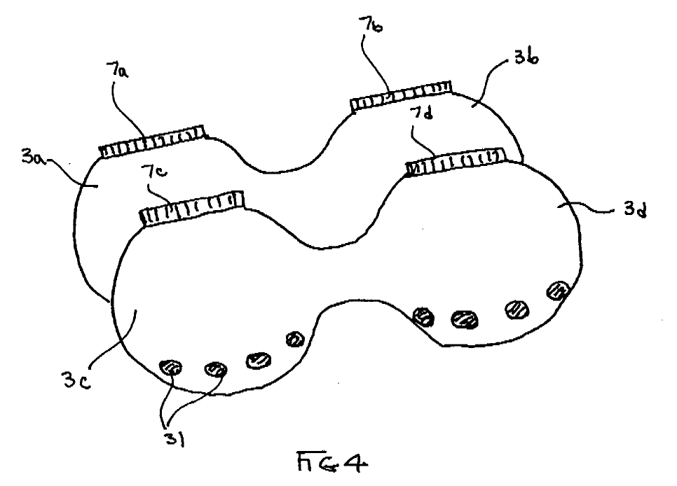

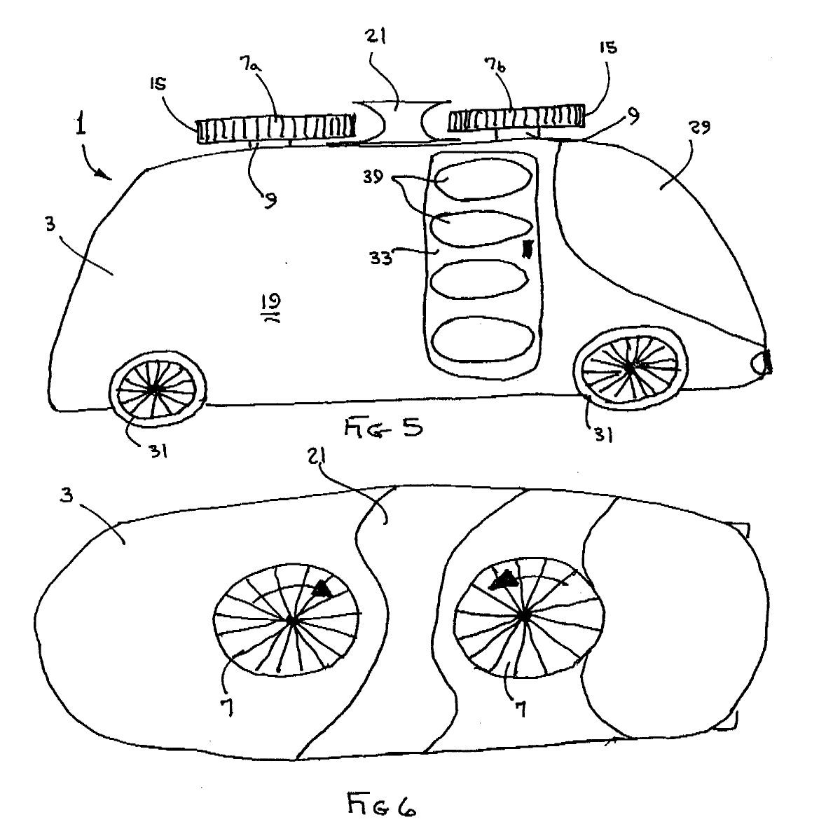

Impeller 7 may be designed to occupy almost the entire overhead space on vehicle 1, as shown in FIG. 3, or be divided into many smaller impellers 7a, 7b, 7c and 7d in multiple-chambered bodies 3a, 3b, 3c, and 3d as shown in FIG. 4 and remain within the spirit and scope of this invention. In addition, body 3 may take on the general appearance of a typical automobile van 19, as shown in FIGS. 5 and 6, where impellers 7a and 7b may be arranged fore and aft on the roof of van 19 separated by a divider wall 21 as shown.

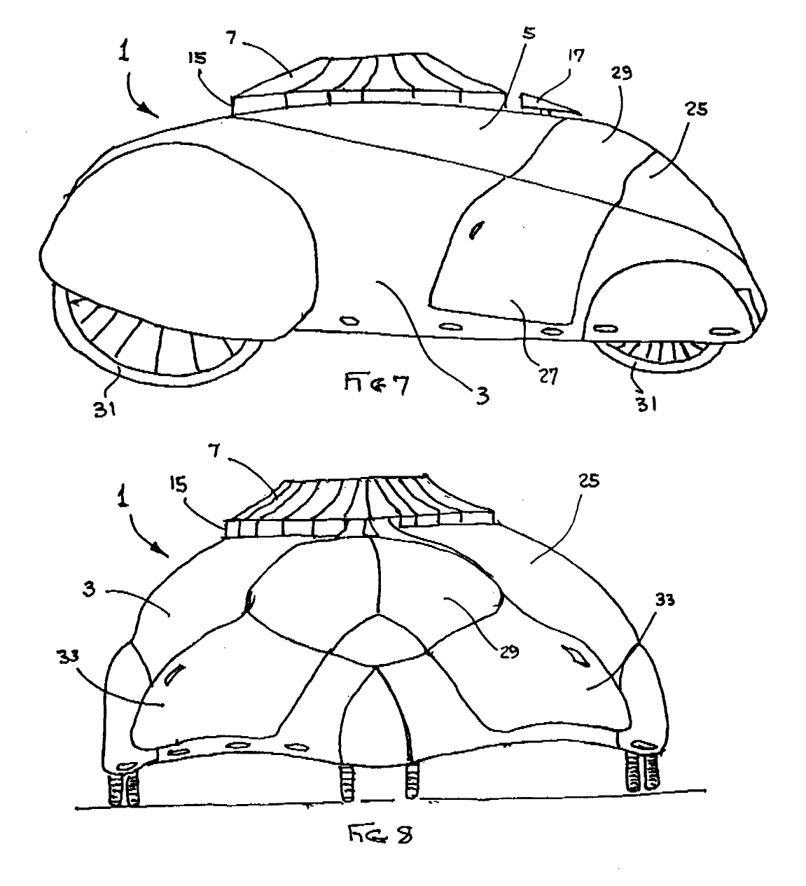

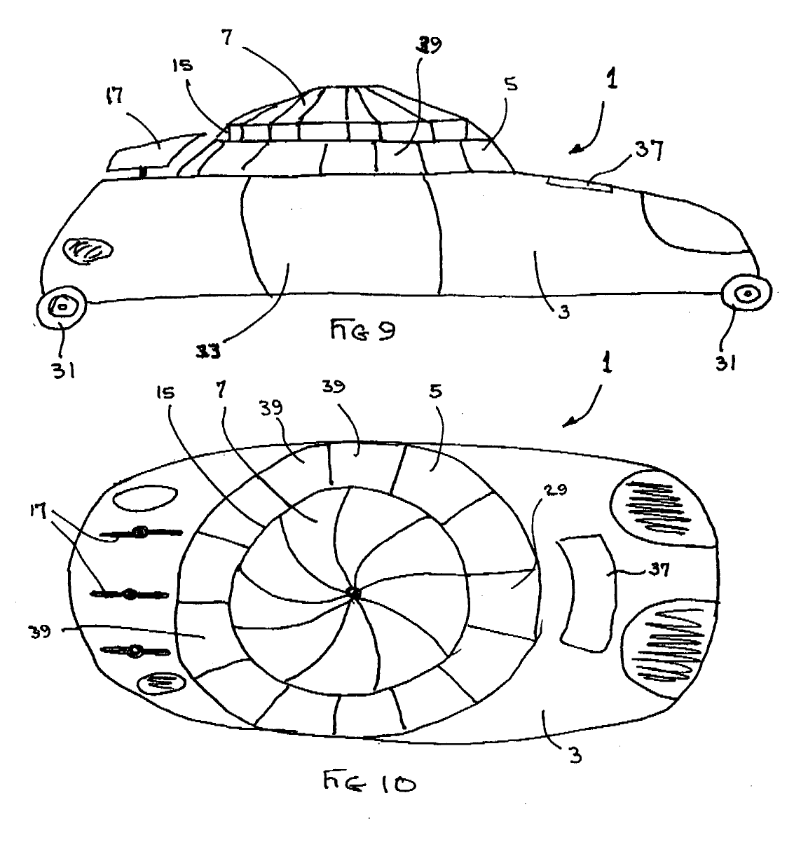

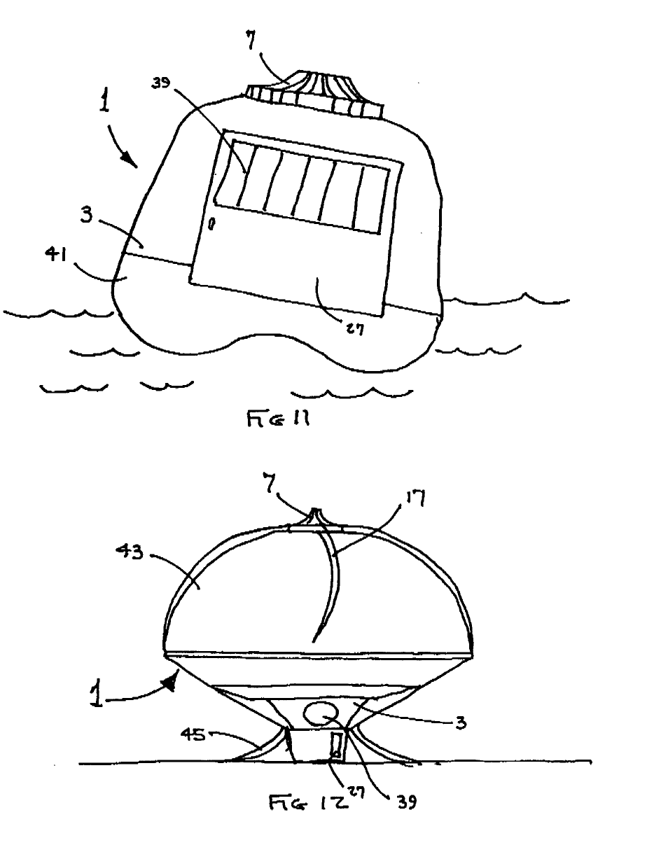

The invention may also be included in a single-occupant or two-occupant sedan or coupe 25, as shown in FIGS. 7 and 8, where the vehicle's body 3 includes an access door 27, driver's windscreen 29 and highway wheels 31 for carrying the vehicle over the road. An even more road-friendly vehicle may be made, as shown in FIGS. 9 and 10, where wheels 31 are accompanied by controllable anti-rotation vanes 17, gull wing doors 33, a safety chute hatch 37, and 360 degrees of outside viewing by the vehicle occupants through windows 39. Finally, vehicle 1 is not confined to only land use while using this invention. As shown in FIG. 11, vehicle 1 may be mated to a lower flotation device 41 for allowing it to be used in and over water.

Still further, vehicle 1 can be made lighter than normal by joining a helium-filled or other light gas-filled envelope 43 with body 3. As shown in FIG. 12, such an envelope 43-hard body 3 combination would lessen the work load on impeller 7 in order to provide sufficient lift to the device. Envelope 43 need not be as large as a typical blimp because much of the lift will be provided by impeller 7. As shown in FIG. 12, in such a combination vehicle, stabilizing landing gear 45 may be included to fold down from the underside of body 3 for contact with the ground.

In tests conducted by the inventor, it was determined that standard impellers, such as of the design used in vacuum cleaners, will demonstrate the principle on which this invention is based. For instance, in tests conducted using a small impeller at a rotation speed of 20,046 rpm (revolutions per minute), the subject body underwent 91 grams of lift. At a rotational speed of 27,000 rpm the lift was increase to 160 grams. At 29,000 rpm the lift increased to 170 grams and, at 29,926 rpm, the lift increased to 186 grams. These tests demonstrate the successful use of a rotating impeller, mounted at the top of an enclosed vehicle, to produce lift without the use of long wings, long rotor blades, and long runways.

We claim:

1. An air vehicle including:
a body including:
a top; and
a bottom;
an impeller mounted on said body for rotating so as to create low pressure on said top of said body relative to the pressure on said bottom of said body to create lift; and
means for rotating said impeller.

2. The air vehicle of claim 1 wherein said body further includes:
a support platform.

3. The air vehicle of claim 1 further including:
buoyant gas in said body sufficient to aid in lift.

4. The air vehicle of claim 1 wherein said body further includes:
control vane means for receiving and directing air from said impeller for controlling orientation of said body.

5. The air vehicle of claim 1 wherein:
said impellor impels air radially outward therefrom.

6. An air vehicle including:
a body including:
a top; and
a bottom;
a plurality of impellers mounted atop said body for rotating so as to create low pressure on said top of said body relative to the pressure on said bottom of said body to create lift; and
means for rotating said impellers.

7. The air vehicle of claim 6 wherein said body further includes:
a support platform.

8. The air vehicle of claim 6 further including:
buoyant gas in said body sufficient to aid in lift.

9. The air vehicle of claim 6 wherein said body further includes:
control means for receiving and directing air from said impellers for controlling orientation of said body.

10. The air vehicle of claim 6 wherein:
said impellers impel air radially outward therefrom.

11. The air vehicle of claim 9 wherein: said control means comprises vents or vanes or both.
